(19) United States
(12) Patent Application Publication
(10) Pub. No.: US 2007/0085285 A1
(43) Pub. Date: Apr. 19, 2007

(54) Cart with precision steering for transporting materials

(76) Inventor: Bruce Lindsay, Fairfield, CA (US)

Correspondence Address: PLAGER LAW OFFICES, 16152 BEACG BLVD., SUITE 207, HUNTINGTON BEACH, CA, 92647, US

(21) Appl. No.: 11/253,512

(22) Filed: Oct. 19, 2005

(51) Int. Cl. B62B 3/00

(52) U.S. Cl. 280/47.34

(57) ABSTRACT

A cart with a manually operated steering mechanism comprising a base coupled to a frame and a cart body with a steering column and steering mechanism. The base further comprises several mechanical steering linkages including a steering push rod, push rod slat, and tie rod; a rack and gear assembly where the gear is coupled to the steering column and the rack is coupled to the steering push rod; and a rack and pinion assembly where the rack is coupled to the tie rod and the pinion is coupled to a pinion shaft whereby a first end engages the rack and a second end is coupled to the steering column through a miter gear assembly. The mechanical linkages are supported by and coupled to the base by support braces and the steering column also capable of being telescopically adjustable.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates to a cart. More specifically, the present invention relates to a cart possessing a manually operated precision steering mechanism articulated by a mechanical linkage between the rear and front of the cart comprising: a slat steering linkage, a rack and gear steering linkage, or a rack and pinion steering linkage.

2. Description of Related Prior Art

Manually operated carts are not new although the mechanisms for effecting their movement continue to change. One of the most common and inexpensive ways of transporting materials is with a utility cart. The utility cart is everywhere and can incorporate a number of different ways for effecting movement:

U.S. Pat. No. 3,485,314 issued to Herr comprises a cart with a front barrow, an internal combustion engine in the barrow, and pivotally attached handlebars for steering.

United States Patent Publication No. US 2004/0216929 filed by White is a scooter comprising front mounted, upright, adjustable handles on a solar-powered base with front castors and a rear axle wheel.

U.S. Pat. No. 4,716,980 issued to Butler and U.S. Pat. No. 5,894,898 issued to Catto are electric scooters with a front-mounted pivoting steering column attached to a single front wheel with a disc braking system.

U.S. Pat. No. 6,709,949 issued to Wang discloses a battery powered personal scooter that can act as a hand truck to move small amounts of cargo when titled.

U.S. Pat. No. 3,720,423 issued to Morris discloses an electric powered cart with a motorized steering column. An operator stands on the cart and tilts the hydraulic steering column located on the forward section of the cart to move it forward or in reverse.

Another common cart apparatus, is one formed from a cart frame and body that sits on top of four castor wheels situated at the four corners of the cart frame. In this way, there is freedom of movement although in order to steer the cart 90 degrees from a given point, the cart operator must apply force from a position opposite to their destination. The problem with this cart arrangement is that oftentimes the load being carried will not allow for the cart operator to push from the opposite side and there is decreased control over the cart movement.

Further, most of the several references disclosed here do not provide for a way for effective negotiation of the cart through narrow passageways, cluttered rooms, kitchens, hallways and other places requiring tight maneuvering such as hospitals and laboratories. For those that do, the steering mechanisms are too bulky, expensive, or prone to mechanical error.

As the previous patents, applications, and common cart uses disclose, there are many techniques for creating movement in carts but they require expensive, maintenance intensive, or extensive operator training to produce or, do not allow for the precision control, maneuverability, or stability that is often required when transporting loads or supplies through narrow corridors or tight corners.

What is needed is a manually operated push cart that can be precisely steered by incorporating a simple and cost-effective steering mechanism.

### SUMMARY OF THE INVENTION

In accordance with the present invention, there is provided a cart that is capable of precision steering using mechanical linkages controlling the movement of a tie rod with wheels.

It is therefore an object of the invention to provide a manually operated cart with a precision steering mechanism comprising a steering push rod, push rod slat, and tie rod.

It is therefore another object of the invention to provide a manually operated cart with a precision steering mechanism comprising a rack and gear assembly.

It is therefore another object of the invention to provide a manually operated cart with a precision steering mechanism comprising a rack and pinion assembly.

It is therefore another object of the invention to provide a manually operated cart with a precision steering mechanism comprising a rack and pinion assembly.

It is therefore another object of the invention to provide a manually operated cart with a precision steering linkage with a telescoping steering column.

It is therefore another object of the invention to provide a manually operated cart with the precision mechanical steering linkages secured to the base by support braces.

It is therefore another object of the invention to provide a manually operated cart with a steering column secured to the cart frame by support braces.

It is therefore another object of the invention to provide a manually operated cart with the mechanical steering linkages secured to the base by support braces.

### BRIEF DESCRIPTION OF THE DRAWINGS

FIG. 1 is a side perspective view of a cart with handlebars and a rack and pinion steering mechanism with a miter gear assembly.

FIG. 2 is a detail view of a miter gear assembly for a cart steering mechanism.

FIG. 3 is a detailed view of a rack and pinion steering assembly.

FIG. 4 is a side view of a rack and pinion steering assembly on a cart with a miter gear assembly for turning a steering push rod.

FIG. 5 is a view of the undercarriage of a cart utilizing the rack and pinion steering assembly.

FIG. 6 is a front view of the rack and pinion steering assembly.

FIG. 7 is a detailed front view of the rack and pinion steering assembly.

FIG. 8 is a rear view of the cart showing the miter gear assembly.

FIG. 9 is a detailed rear view of the miter gear assembly.

FIG. 10 is a view of the undercarriage of a cart utilizing a push slat steering mechanism with a rack and gear steering assembly and where the wheels are turned to the left.

FIG. 11 is a view of the undercarriage of a cart utilizing a push slat steering mechanism with a rack and gear steering assembly where the wheels are turned to the right.

FIG. 12 is an elevated perspective view of a cart showing the rack and gear steering assembly.

FIG. 13 is a detailed perspective view of the rack and gear steering assembly and steering column support.

FIG. 14 is a view of the undercarriage of a cart utilizing a push slat steering mechanism with an angle slat steering assembly and where the wheels are turned to the left.

FIG. 15 is a view of the undercarriage of a cart utilizing a push slat steering mechanism with an angle slat steering assembly and where the wheels are turned to the right.

FIG. 16 is an elevated perspective view of a cart showing the push rod steering assembly utilizing an angle slat.

FIG. 17 is a detailed view of the angle slat steering assembly.

FIG. 18 is a view of a locking pin mechanism for a telescoping steering column.

FIG. 19 is a detailed view of a locking pin mechanism for a telescoping steering column.

FIG. 20 is a view of a spring biased locking mechanism for a telescoping steering column.

FIG. 21 is a detailed cross-sectional view of a spring biased locking mechanism for a telescoping steering column.

FIG. 22 is a perspective view of a telescoping steering column with a crimping nut locking mechanism.

FIG. 23 is a detailed view of a telescoping steering column with a crimping nut locking mechanism.

FIG. 24 is a cross-sectional view of a telescoping steering column with a crimping nut locking mechanism.

### DETAILED DESCRIPTION OF THE DRAWINGS AND PREFERRED EMBODIMENTS

A complete understanding of this invention can be gained through reference to the drawings in conjunction with a thorough review of the disclosure herein. To facilitate this understanding, a table of commonly used reference numerals is provided.

| | |
|---|---|
| 04 | support braces |
| 10 | cart |
| 11 | wheels |
| 12 | steering shaft support |
| 14 | steering column |
| 15 | steering column support |
| 16 | cart body |
| 17 | handlebars |
| 20 | bolt and bearing assembly |
| 21 | angle slat |
| 22 | angle slat pivot |
| 23 | steering push rod |
| 24 | tie rod |
| 25 | tie rod bracket pivot |
| 26 | push rod support brackets |
| 27 | tie rod bracket |
| 28 | push rod slat |
| 29 | gear |
| 30 | rack |
| 31 | tie rod rack |
| 32 | steering rod shaft |
| 33 | steering shaft pinion |
| 39 | miter gear head (steering column) |
| 43 | miter gear box |
| 49 | miter gear head (steering rod shaft) |
| 52 | inner tube |
| 53 | outer tube |
| 54 | adjustment hole |
| 55 | clevis/locking bolt |
| 56 | cotter key/safety pin |
| 57 | spring |
| 58 | button |
| 59 | tapered thread |
| 61 | keyway |
| 62 | key |
| 63 | vertical slots |
| 60 | crimping nut |

Overview

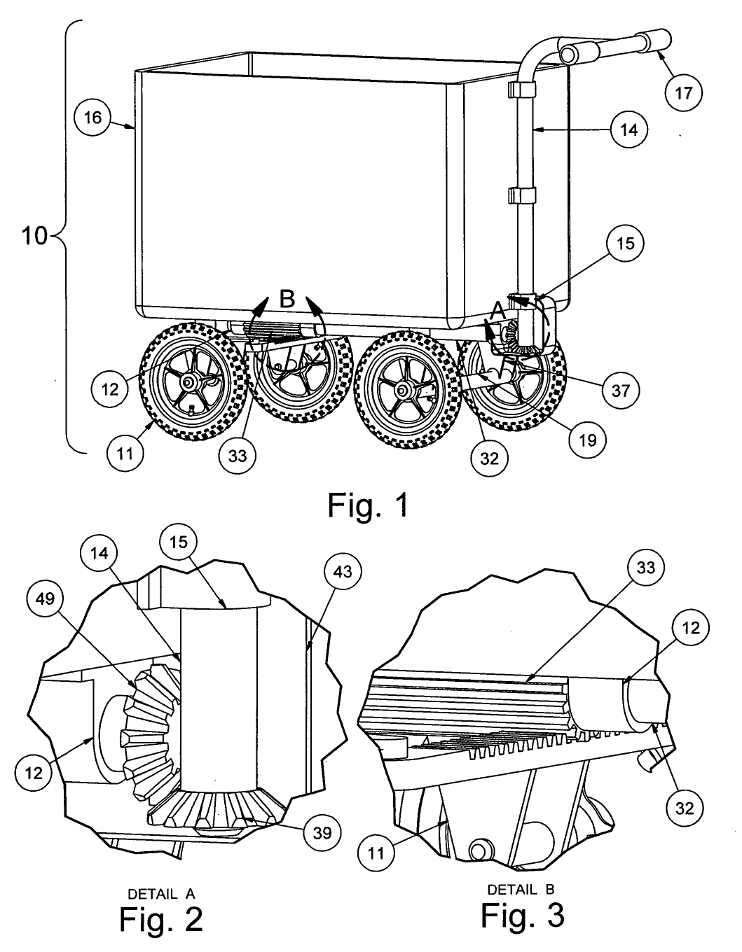

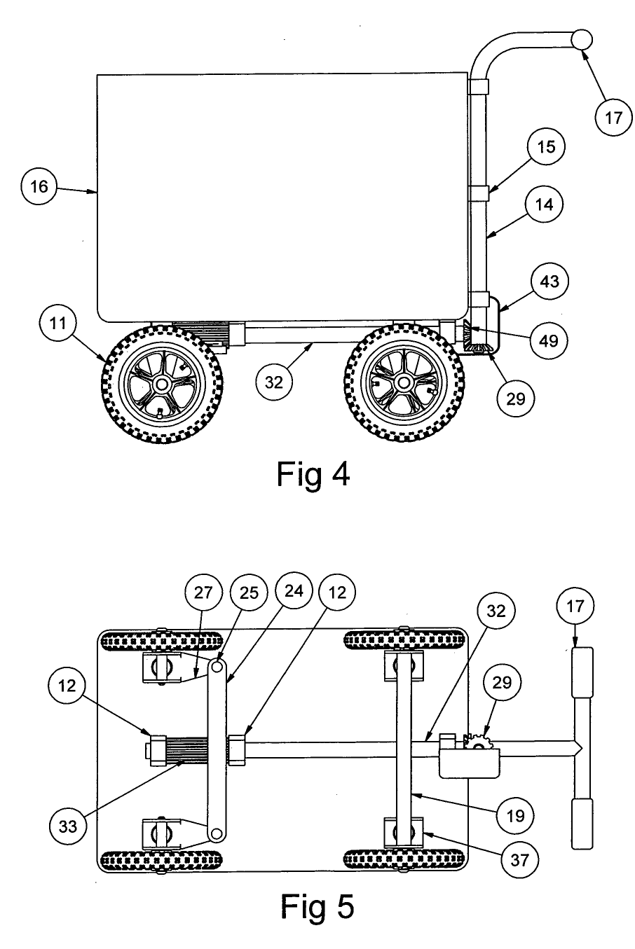

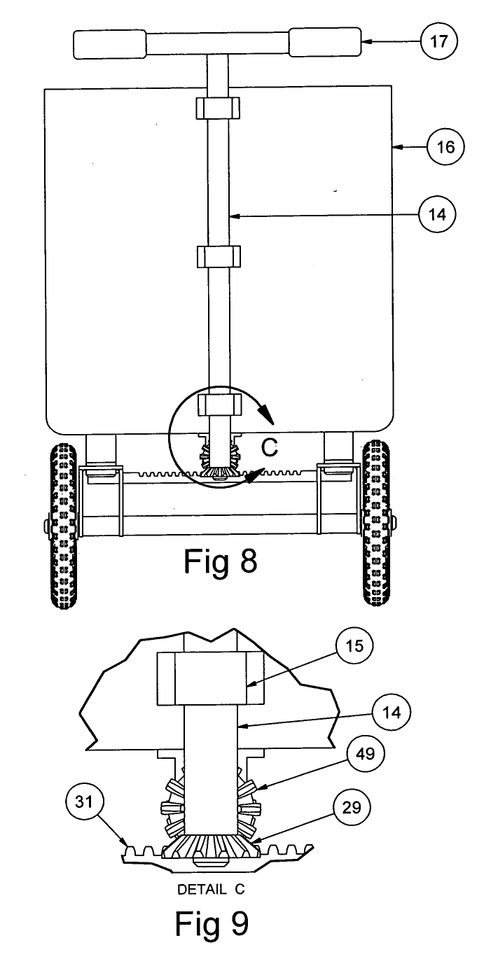

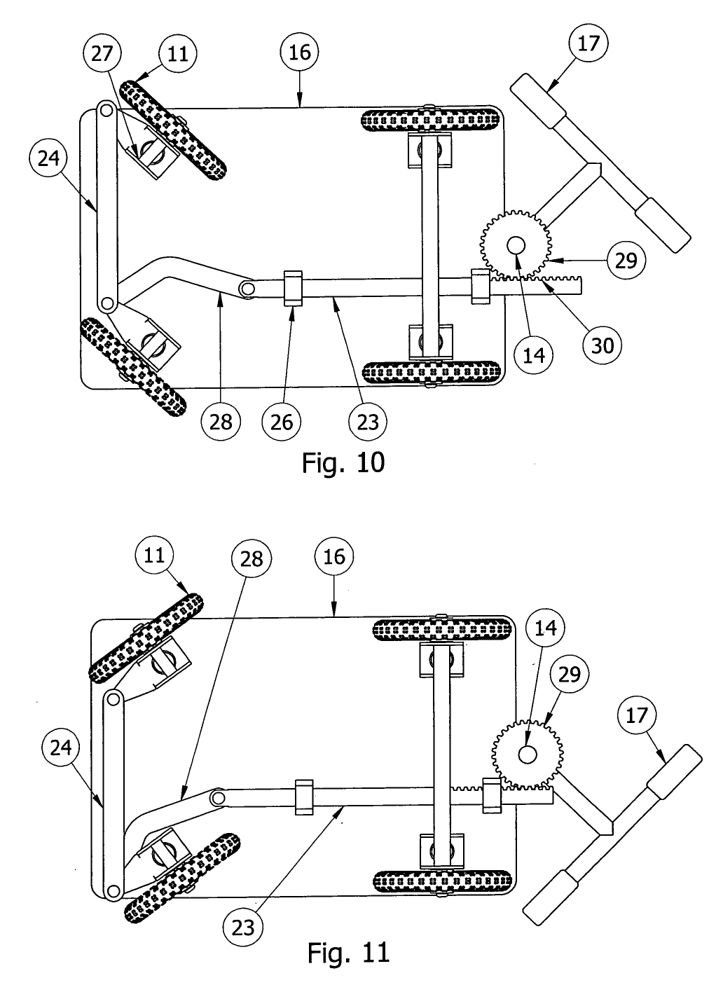

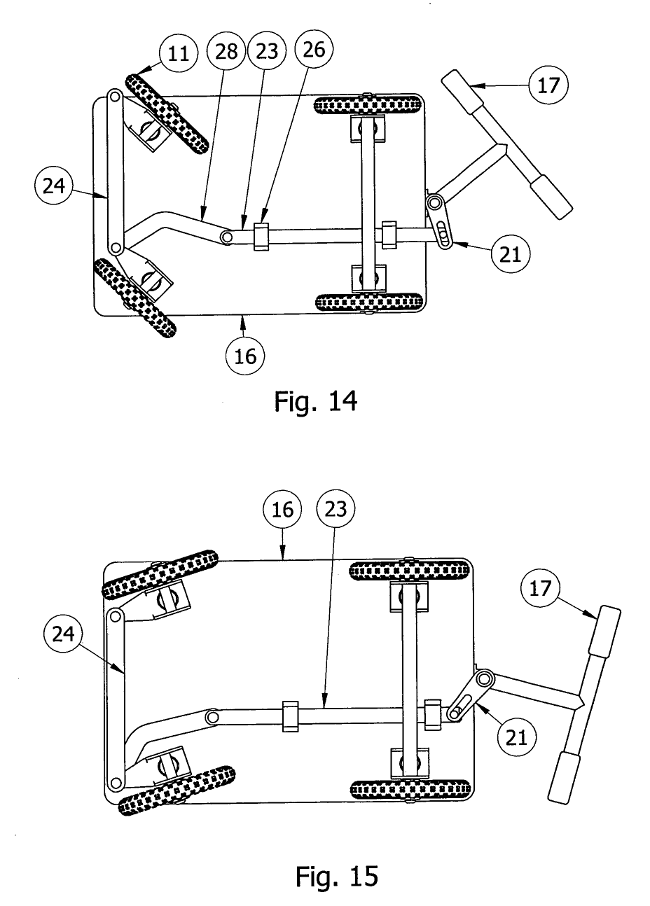

The apparatus and its several embodiments as described herein provide for a cart capable of precision steering. As generally seen in FIG. 1 a precision steering cart 10 typically comprises a cart body 16, steering column 14, a steering assembly and wheels 11, and a rear axle 19 and wheels 11 provide a known means for effectuating rolling movement of the cart. As a means for steering the cart, a steering column 14 is secured to the cart body 16 and one of several mechanical linkages are coupled to the steering column 14 that operates to create precision steering of the cart. Here, the present invention can take on several different steering assemblies: slat (FIGS. 14-17), slat using a rack and gear steering turning assembly, (FIGS. 10-13) or rack and pinion steering. (FIGS. 1-9)

Slat Steering Assembly

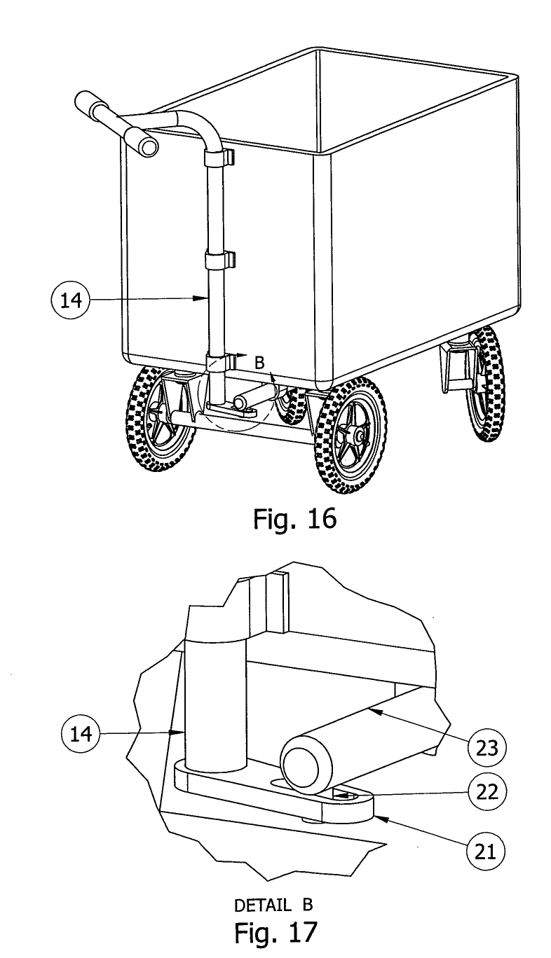

FIG. 16 shows a perspective view of a cart with push rod slat steering. Handlebars 17 are connected to the steering column 14. The handlebars 17 provide the operator a means to rotate the steering column 14 and guide the cart precisely. The handlebars 17 must also support the force of the operator while being operated. Turning the handlebars transfers the steering force of the operator to the steering column 14. The steering column 14 is secured to the cart body 16 through one or more steering column supports 15. The cart body 16 further provides a place to store materials for transport. Underneath the cart body are the steering assemblies which also act as a frame to hold up the cart body and to which are fastened wheels 11.

One exemplary embodiment for creating precision steering of a cart is through a slat steering system illustrated by FIGS. 14, 15, 16, and 17. The slat steering embodiment generally comprises a steering column 14 secured by steering column supports 15 to an angle slat 21 with an aperture capable of receiving an angle slat pivot 22. (See, FIG. 17, Detail B) The angle slat pivot 22 is attached through known means such as welding, to a steering push rod 23. The steering push rod 23 is further pivotally connected to a push rod slat 28 that, in turn, is pivotally connected to a tie rod 24.

FIG. 14 is a view of the undercarriage of the cart with a slat steering system. The steering system is controlled by the steering column 14 that rotates the handlebars 17 (FIG. 16) under the control of an operator. The steering column 14 through its rotational motion rotates the angle slat 21. The rotational motion of the angle slat 21 is transformed to linear motion from the angle slat 21 and angle slat pivot 22 to the steering push rod 23. The effect of this transfer is that the steering push rod 23 will move forward or backward depending on the rotational movement of the steering column 14 and angle slat 21.

In an exemplary embodiment, the steering push rod 23 is supported by one or more steering push rod support brackets 26. The brackets can be attached to the cart body 16 with rivets or any other known and available means for securing them in place. The steering push rod 23 is connected to the tie rod 24 through a push rod slat 28. The tie rod 24 is secured to a tie rod bracket 27 to which wheels 11 are fastened through bearings or other available means for rotation. The tie rod bracket 27 is a rigid support with known attachment mechanisms, such as ball bearing and bolt assemblies, for fastening wheels 11. The tie rod brackets 27 are pivotally attached to the underside of the cart body 16 so that when the push rod slat 28 is pushed or pulled by the steering push rod 23, the wheels 11 will be able to turn relative to the force of that movement. The push rod slat 28 is preferably pivotally fastened to the push rod by means of a bolt pivot or other known pivoting means, driven through the push rod 23 and the push rod slat 28. The push rod slat 28 can be pivotally fastened to the tie rod in the same way.

The linear motion of the steering push rod 23 is transferred to the push rod slat 28 and then to the tie rod 24. This allows the wheels 11 to be rotated at an angle relative to the movement of the steering column 14. In a preferred embodiment, the push rod slat 28 is secured to the right side of the tie rod 24 thereby creating a turning motion proportionate to the direction of the steering column 14. However, in another embodiment, the push rod slat can be secured to the left side of the tie rod creating a motion opposite to the direction of the steering column 14.

In the preferred embodiment, when the steering column 14 is rotated counterclockwise, the steering push rod 23 moves forward and turns the wheels 11 in a counterclockwise direction. When the steering column 14 is rotated clockwise, the steering push rod 23 moves toward the operator causing the wheels 11 to move clockwise.

Push Rod Steering with Rack and Gear Turning Assembly

In another exemplary embodiment illustrated in FIGS. 10, 11, 12, and 13 whereby precision steering is created by a steering column 14 that transfers its rotational movement to a steering push rod 23 via a gear 29 and rack 30 assembly at the back of the cart. FIG. 10 is view of the undercarriage of a cart utilizing this steering system that is similar to the slat steering system but instead, uses a gear 29 and rack 30 to effect the linear motion of the steering push rod 23. In this embodiment, the steering system is controlled by a steering column 14 that is rotated by handlebars 17, steering wheel, or other steering assembly capable of effecting a rotational movement to the steering column.

Mounted on or to the steering push rod 23 is a rack 30 and mounted on the steering column 14 is a gear 29. When the steering column is rotated, the gear 29 engages the rack 30 and pushes the steering push rod 23 toward the front of the cart or pulls the push rod 23 toward the back of the cart rod depending on the direction of rotation of the steering column. The rotational motion of the gear 29 is transformed to linear motion by the push rod rack 30 that is, in turn, attached to the steering push rod 23.

The steering push rod 23 is supported by one or more steering push rod support brackets 26 that are fastened to the underside of the cart 16 in the same way as the slat steering system. Additionally, and as in the prior steering linkage, the brackets 26 provide for free movement of the steering push rod 23 so as not to impede its rotation.

The steering push rod 23 is connected to the tie rod 24 via the push rod slat 28. The push rod slat 28 is pivotally fastened to the push rod by means of a bolt pivot or other known pivoting means, driven through the push rod 23 and the push rod slat 28. The push rod slat 28 can be pivotally fastened to the tie rod in the same way.

The tie rod bracket 27 is a rigid support with known attachment mechanisms for fastening wheels 11 such as a bearing assembly or other known means for allowing their free rotation. The tie rod bracket is secured to the tie rod 24 using known techniques such as rivets or other means for securely fastening pieces of metal in place. However, and similar to the push rod slat steering system, the tie rod bracket 27 is pivotally attached to the underside of the cart body 16 so that the wheels are able to turn when the linear motion of the steering push rod 23 is pushed forward toward the front of the cart.

When the steering column 14 is rotated counterclockwise, the gear 29 engages the rack 30 and the steering push rod 23 moves forward and turns the wheels 11 in a counterclockwise direction. When the steering column is rotated clockwise, the steering push rod 23 moves toward the operator causing the wheels to move clockwise.

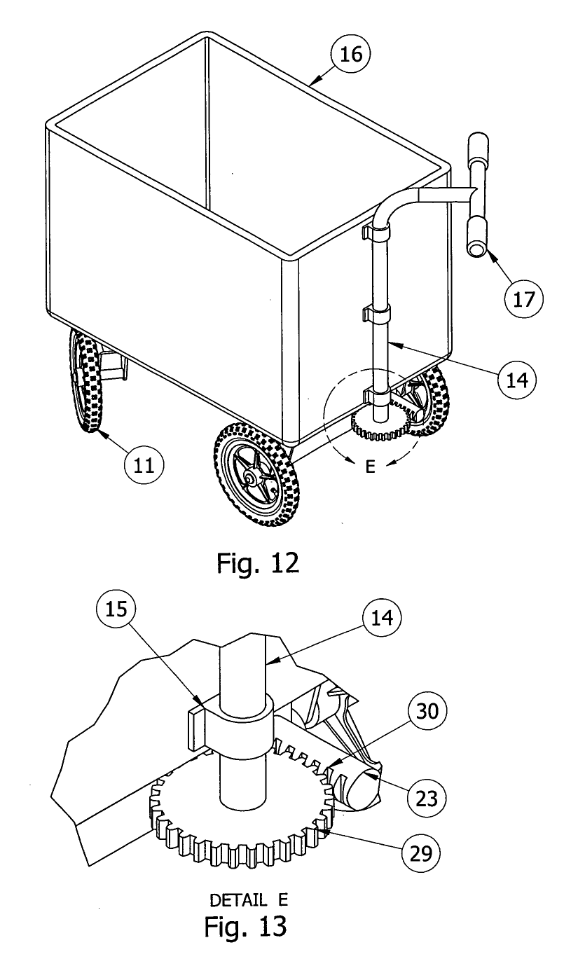

FIGS. 12 and 13 illustrate the above-described movement. In FIG. 12, the steering column 14 and handlebars 17 are turned to the left of the cart whereby the gear 29 is rotated left and toward the back of the cart. The rotational movement is transferred to linear motion of the rack 30 toward the front of the cart, thereby pushing the push rod 23, push rod slat 28 and tie rod 24 forward and turning the wheels to the right. The opposite movement occurs when the steering column 14 and handlebars 17 are turned to the left.

However, in another embodiment, the push rod slat 28 can be secured to the left side of the tie rod 24 creating an opposite motion of the tie rod 24 than that just described. In this embodiment, turning the handlebars 17 to the right pushes the steering push rod 23 and push rod slat 28 to the left causing the tie rod 24 to turn right, and vice versa.

Rack and Pinion Steering Assembly

In another embodiment, the use of a rack and pinion system is used to effectuate steering movement of the cart. FIGS. 1 through 9 are illustrative of the preferred method for effectuating this movement through a tie rod rack 31 and pinion 33 assembly used to turn the tie rod 24 and a miter gear assembly (Shown in detail in FIG. 2).

FIG. 1 is a perspective view of the cart with a rack and pinion steering system. The steering system is controlled by the steering column 14. The steering column 14 is rotated by handlebars 17, steering wheel, or other steering assembly capable of effecting rotational movement of the steering column. The steering column 14, during its rotation, further rotates miter gears 39 49 housed in a miter gear box 43 shown in cross-sectional detail in FIG. 2.

The purpose of the miter gear assembly is to transmit the steering power at a 90 degree angle through two involute miter gear heads 39 49. The miter gear box 43 provides an enclosure for the miter gears 39 49 such that they are at a 90 degree angle to each other where each miter groove on one miter gear is paired to the comparable groove on the other. One miter gear 39 is attached to the steering column 14 and the other miter gear 49 is attached to the steering end of the steering rod shaft 32. Further, and in an exemplary embodiment the miter gears 39 49 can be coupled to the steering column 14 and steering rod shaft 32 through miter bolts. In addition, the steering column 14 and steering rod shaft 32 can utilize bearing assemblies to ease the friction when turning the steering column. Also, a seal between the miter box and the bearings can be used to provide elasticity and to prevent loss of any miter box lubricant that might be used.

The rotational motion of the miter gears rotates the steering rod shaft 32 which, in turn rotates the steering shaft pinion 33. The pinion 33, when turned, transfers its motion to the tie rod rack 31 which can be attached separately or integrated into a tie rod 24 like those previously described herein. The steering rod shaft 32 is, preferably, supported by steering shaft supports 12 shown in detail in FIG. 2. The steering shaft supports 12 are attached to the cart body 16 with rivets or other known fastening means readily available in the art and have a circular aperture capable of receiving the shaft 32.

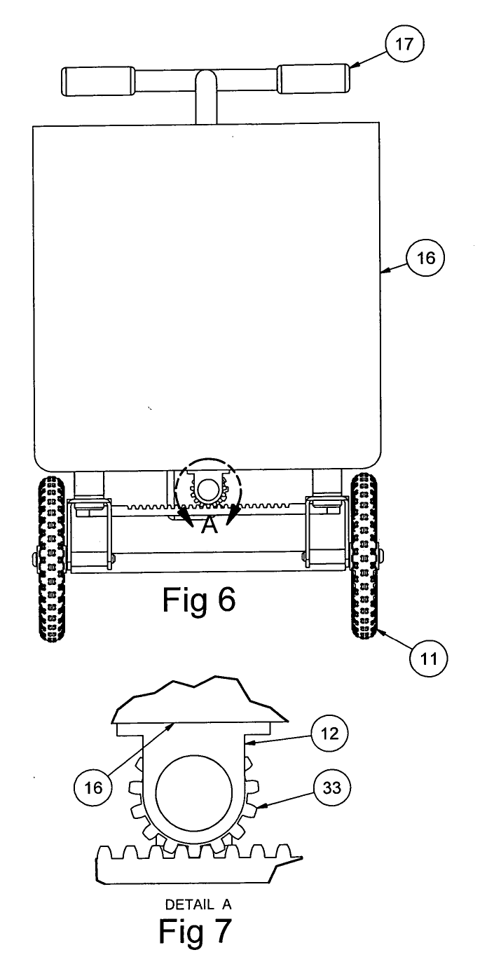

In the rack and pinion steering linkage, the tie rod rack 31 is pivotally attached 25 (FIG. 5) to the tie rod brackets 27 that are, in turn, pivotally mounted to the underside of the cart body 16 to allow for turning when the pinion is turned on the rack. Wheels are fastened to the tie rod brackets 27 such that they can effect rotational movement through the use of a bolt and bearing assembly 20 or other known means for allowing rotational movement. The tie rod brackets 27 can be fastened directly to the underside of the cart body 16 or the distance between the cart body and the tie rod brackets 27 can be offset through support braces 4 (FIG. 6) secured to both the tie rod brackets 27 and the underside of the cart body 16.

When the steering column 14 is rotated, a clockwise rotational motion is transferred by the miter gears into a counterclockwise motion to the steering rod shaft 32. The counterclockwise rotation of the steering rod shaft 32 is transferred to horizontal motion by the pinion 33 working against the tie rod rack 31 to the left of the cart. The horizontal motion of the pinion 33 against the rack 31 pushes it in the opposite direction which is allowed by the pivoting 25 action of the tie rod brackets 27 relative to the tie rod brackets 31.

Therefore, when the steering column 14 is rotated clockwise, the steering rod shaft 31 and pinion 33 are turned counterclockwise. The pinion pushes against the tie rod rack 31 to the right causing the tie rod brackets 27 to pivot and turn to the right. The opposite effect occurs when the steering column is turned counterclockwise.

There are various alternatives to the ancillary portions of the present invention that can be easily identified by those skilled in the art. For example, power can be effectuated through the use of various engine assemblies such as internal combustion, solar power, and other known methods for moving framed bodies. These engine assemblies can then be connected to the cart through known drive train assemblies such as those in automobiles. However, the precision steering of the present invention will not be affected since it is independent of the mechanisms for powering the cart

Telescoping Steering Column

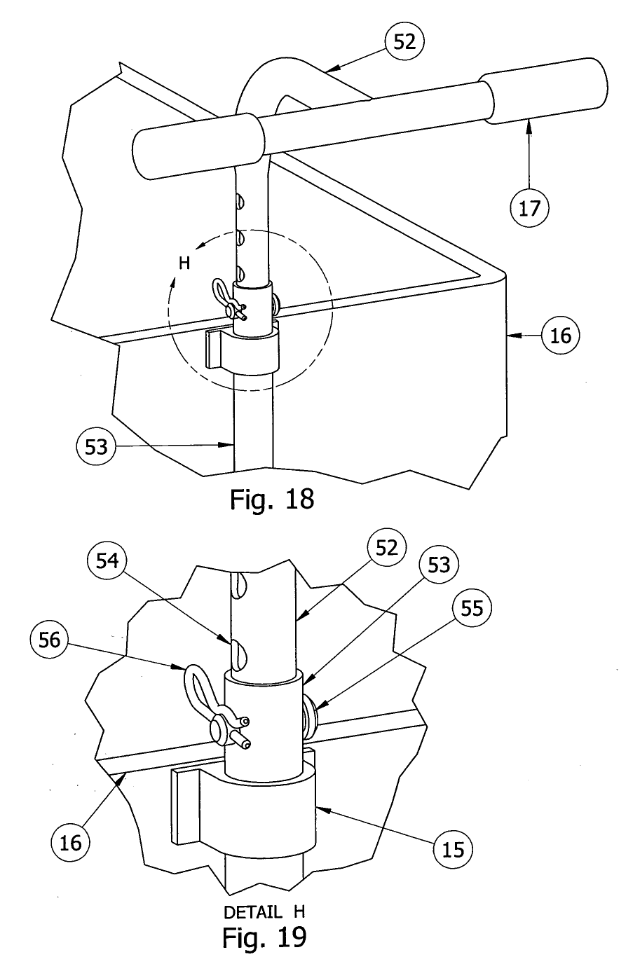

It is preferred the handlebars are located at the topmost portion of the steering column which is preferably at the waist level of a person of average height. To maintain the appropriate height of the handlebars, the steering column may be telescopically adjustable. FIGS. 18-24 show several exemplary embodiments for allowing the column to telescope.

FIGS. 18 and 19 depict a telescoping steering column utilizing a cotter pin 56 locking assembly. In this embodiment the steering column is made of two separate but interchangeable tubes. The first is an inner tube 52 that fits within an outer tube 53. The inner tube has holes 54 drilled or otherwise formed at various distances on it large and long enough to fit a locking bolt 55, and the locking bolt having a small aperture on the end capable of receiving the cotter pin 56. Situated on the outer tube is a hole also large enough to accommodate the bolt 55. Once the inner tube 52 is fitted into the outer tube 53 and the desired length (determined by aligning the appropriate hole on the inner tube with hole on the outer tube) is configured, the bolt can then be fitted into both holes and prevented from sliding out by securing the cotter pin 56 through the small aperture at the end of the bolt 55.

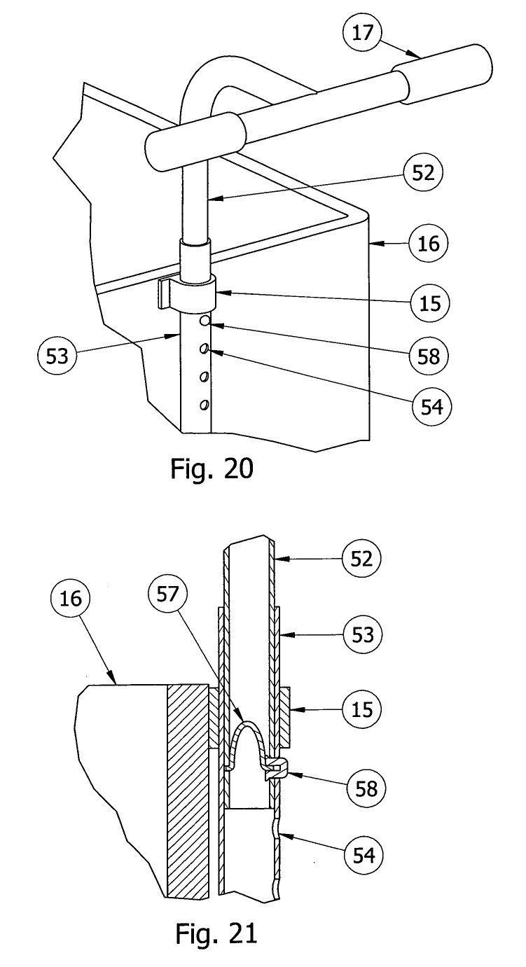

In a similar exemplary embodiment, shown in FIG. 20, multiple holes 54 are formed in the outer tube 53 and only one hole need be formed in the inner tube 52. In this way, the holes in the two tubes can be aligned and secured through the use of a simple bolt or other pin to prevent the inner tube 52 from slipping.

In another exemplary embodiment, holes 54 are formed in the outer tube 53 and a spring 57 secured to a button 58 through spring tension is biased in the inner portion of the inner tube 52. In this way, once the inner tube 52 is lifted to a desired height, the button 58 can be aligned with a hole 54 capable of receiving the button 58. To realign the inner tube 52, an operator simply has to press in the button 58 against the spring 57 and readjust the inner tube 52. Once realigned, the spring 57 will push against the button 58 and lock it into the new hole.

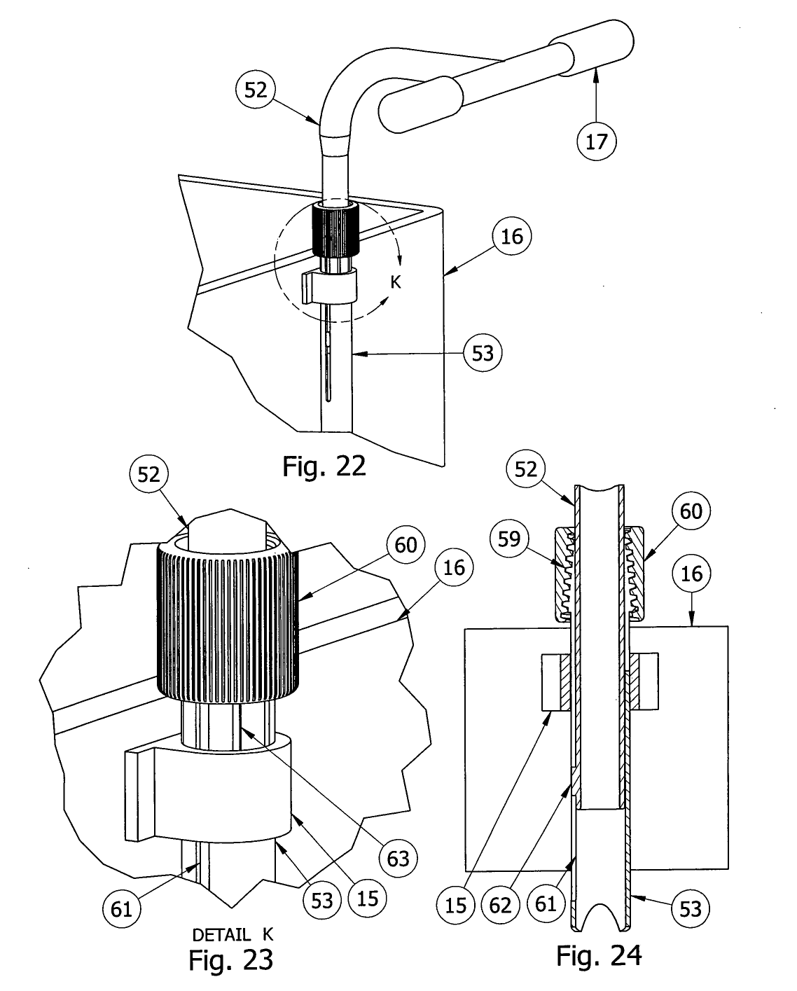

In still another exemplary embodiment, the steering column may be telescopically adjustable through the use of a crimping nut 58 secured to the top of the column. FIGS. 22, 23, and 24 illustrate this embodiment. FIG. 22 shows an outer tube 53 and inner tube 52 attached to the body of the cart 10.

FIG. 23 shows a crimping nut 60 on inner tube 52 attached to the cart body 16. A keyway 61 with key 62 keeps the inner tube 52 and outer tube 53 locked together. The steering column is secured to the cart by steering column supports 15. Vertical slots 63 provide lateral expansion room for the inner tube 52 material as it is compressed by the crimping nut 60 when the inner tube is slid up and down through the crimping nut.

FIG. 24 shows a crimping nut 60 engaging the outside of an inner tube 52 attached to cart body 16. Keyway 61 with key 62 keeps the inner tube 52 and outer tube 53 locked together. The steering column 14 is secured to the cart by steering column supports 15. The crimping nut 60 is turned counterclockwise to progress down the tapered threads 59. The crimping nut 60 is turned clockwise to progress up the tapered threads 59. This allows the user to adjust the height in a continuous manner.

### CONCLUSION, RAMIFICATIONS, AND SCOPE

While the above description contains various preferred, exemplary, and other specific embodiments, these should not be construed as limitations on the scope of the invention, but as exemplifications of the presently preferred embodiments thereof. Many other ramifications and variations are possible within the teaching of the invention.

Thus the scope of the invention should be determined by the appended claims and their legal equivalents, and not solely by the examples given.

1. A cart with a manually operated steering mechanism comprising:
a cart body with a front and rear, and a steering assembly;
the steering assembly further comprising a steering push rod, a push rod slat, and a tie rod with means for securing to the front end of the cart body;
a steering column comprising a means for securing to the cart body, a steering means, and a means for pushing the steering push rod;
the steering push rod having a means for pivotally attaching to the push rod slat and pivotally attaching to the tie rod;
the tie rod coupled to a left and right tie rod bracket, each tie rod bracket having means for pivotally attaching the cart body; and
means for rolling the cart coupled to the left and right tie rod bracket and the rear of the cart.

2. The cart of claim 1 wherein:
the steering push rod comprises an angle slat pivot;
the means for pushing the steering push rod comprises an angle slat with a first and second end wherein the first end comprises means for securing to the steering column and the second end having an aperture capable of receiving the angle slat pivot;
the cart body further comprises a rear with a left and right side;
the cart body further comprises a rear axle with a left and right side coupled to the cart body; and
the means for rolling the cart comprises a first and second wheel rotatably mounted to the left and right tie rod brackets, respectively, and a third and fourth wheel rotatably mounted to the left and right side of the rear axle, respectively.

3. The cart of claim 2 wherein:
the steering means comprises a handlebar with a first and second handle;
the means for securing the steering column to the frame comprises one or more steering column support braces; and
the means for securing the steering push rod to the base comprises support braces with means for securing the support braces to the cart body.

4. The cart of claim 1 wherein:
The steering push rod comprises a front and rear;
the means for pushing the steering push rod comprises a gear coupled to the steering column, and a rack coupled to the rear of the steering push rod operatively positioned to the gear whereby rotating the steering column engages the gear and rack thereby pushing or pulling the steering push rod depending on the rotation of the steering column;
the cart body further comprises a rear with a left and right side;
the cart body further comprises a rear axle with a left and right side coupled to the cart body; and
the means for rolling the cart comprises a first and second wheel rotatably mounted to the left and right tie rod brackets, respectively, and a third and fourth wheel rotatably mounted to the left and right side of the rear axle, respectively.

5. The cart of claim 1 wherein the means for coupling the steering push rod to the base comprises shoulder bearings secured by clevis pins.

6. The cart of claim 1 wherein the means for coupling the steering push rod to the base comprises shoulder bearings secured to the base by rivets.

7. A cart with a manually operated steering mechanism comprising:
a cart body with a front, rear, top, and bottom;
a steering assembly on the cart comprising:
a steering rod with a front and rear,
a tie rod with a right and left side,
a steering column with a steering means, a means for securing to the cart body, and means for engaging and turning the steering connecting rod,
the rear of the steering connecting rod having means for engaging the steering column and the front having a pinion, and
the tie rod having a rack capable of engaging the pinion,
left and right tie rod brackets with means for pivotally attaching to the tie rod and means for pivotally attaching to the cart body,
a rear axle with a left and right side with means for securing to the cart body; and
wheels for rolling the cart with means for rotatably securing to the left and right side of the rear axle and to the left and right tie rod brackets.

8. The cart of claim 7 wherein:
the means for securing the steering column to the cart body comprises one or more steering column support braces;
the steering means comprises a steering wheel mounted to the steering column; and
the means for engaging and turning the steering connecting rod and means for engaging the steering column comprises a miter gear assembly.

9. The cart of claim 7 wherein the means for coupling to the base comprises shoulder bearings secured by clevis pins.

10. The cart of claim 7 wherein the means for coupling to the base comprises shoulder bearings secured to the base by rivets.

11. The cart of claim 1 wherein the steering column incorporates a telescoping means for elongating or shortening to comport with the operator's height.

12. The cart of claim 11 wherein the telescoping means comprises a steering column with:
an inner tube comprising one or more spaced apertures,
an outer tube capable of receiving the inner tube and also having a single aperture capable of aligning with the one or more spaced apertures of the inner tube,
and a cotter pin and safety pin capable of fitting through the aligned holes in the inner and outer tube.

13. The cart of claim 11 wherein the telescoping means comprises a steering column with:
an inner tube incorporating a spring biased against a button inside the inner tube, and
an outer tube with one or more spaced apertures capable of receiving the button.

14. The cart of claim 11 wherein the telescoping means comprises a steering column with an inner tube comprising tapered threads and a crimping nut, and an outer tube capable of receiving the inner tube and having a keyway and key such.
